(19) United States
(12) Patent Application Publication
(10) Pub. No.: US 2015/0033238 A1
(43) Pub. Date: Jan. 29, 2015

(54) SYSTEM COMPRISING A CLUSTER OF SHARED RESOURCES COMMON TO A PLURALITY OF RESOURCE AND TASK MANAGERS

(71) Applicants: Yann MAUPU, Arpajon (FR); Thomas CADEAU, Massy (FR)

(72) Inventors: Yann MAUPU, Arpajon (FR); Thomas CADEAU, Massy (FR)

(73) Assignee: BULL SAS, Les Clayes sous Bois (FR)

(21) Appl. No.: 14/338,460

(22) Filed: Jul. 23, 2014

(30) Foreign Application Priority Data
Jul. 24, 2013 (FR) 13 57 300

(51) Int. Cl. G06F 9/50

(52) U.S. Cl. CPC G06F 9/5088
USPC 718/104

(57) ABSTRACT

A system is provided including at least two resource and task managers which are independent of each other; a cluster of shared resources common to these managers; software that runs in the background interfaced with the managers in a manner so as to appropriately distribute the resources of the cluster between the managers on the basis of one or more distribution parameters.

### FIELD OF THE INVENTION

The invention relates to a system comprising a cluster of shared resources common to a plurality of resource and task managers. The invention also relates to the method for distributing these resources over time amongst the managers, as well as to the associated distribution device. The invention relates in particular to a device that provides the ability to use two resource and task managers that are independent or indeed even different installed on the same cluster and working on a group of common computing nodes.

### BACKGROUND OF THE INVENTION

A particular type of device for managing resources and tasks known as a Resource and Job Management System or RJMS, is responsible for distributing computing power to the applications. This manager plays a central role in the execution stack as it is the interface between the user domain and the cluster (cluster of computing nodes). A user requests this task manager to perform a task by submitting this task to it. This task is in particular defined by a maximum execution time and a number of computing nodes needed to perform it. These parameters enable the manager to schedule all of the tasks in order to ensure their optimal distribution. The main objective is to have a maximum of nodes in use in a continuous and ongoing basis, which optimises the overall efficiency of the entire cluster.

According a first example of the prior art, it is a known practice to use one single manager that is installed for managing all the nodes in a cluster. This implies having prior knowledge of or learning about the operation of this manager. In addition, changing the manager involves a period of transition and a temporary shut down of production, that is to say a break in the data processing flow.

When one manager is to be replaced by another manager, the computing nodes are initially all allocated to the previous manager prior to the transition, and then they are subsequently all allocated to the new manager after the transition.

In order to carry out a smoother transition, it is envisaged, in accordance with the invention (this does not exist in the known prior art), to arrange for the sharing, during a progressive transition phase without temporary shut down of production, of a cluster of computing nodes among a plurality of managers.

In this case, when replacing one manager by another manager, whether the latter is of the same type or a different type, and more generally in a situation where, at any given time, a cluster of computing nodes is common to a plurality of managers, for example, to two managers, a problem that arises, is that of ascertaining how one of the managers can determine the list of nodes used by a task managed by the other manager.

According to a second example of the prior art, it is a known practice to use a command “wrapper”. Such a wrapper for commands makes it possible to render the usage by one manager transparent, either by creating general commands whose parameters would be adapted to the manager, or by simulating the commands of a first manager, calling the commands of a second manager.

This second prior art presents several disadvantages. Firstly, it does not provide for the use of multiple managers simultaneously. Then, a wrapper is simply not enough for trying out a manager. In fact, this requires a complete installation and configuration of the new manager, which severely disrupts production. In addition, a wrapper does not take into account the differences in behaviour of each manager in particular. Finally, the options for commands can be very different from one manager to another. A wrapper is not able to take into account all of the functionalities of each manager in particular.

One potential solution for determining how to manage the amount of nodes allocated to each manager without interrupting production would be to have a manager of managers (RJMS of RJMSs), that is to say, to have a super manager (super RJMS). Such a super manager does not exist in the prior art and it could present a potential solution to the problem addressed by the invention.

However, according to the invention, such a solution would present a relatively high degree of complexity and would require a relatively significant level of resources for it to function. Moreover, it is likely that with such a double level of managers, the managers would be constrained by the super manager and would be unable to either perform to their full potential or bring to bear their usual advantages.

### SUMMARY OF THE INVENTION

The goal of the present invention is to provide a system and a resource distribution device for distributing resources over time while at least partially overcoming the aforementioned drawbacks.

In particular, the object of the invention relates to providing a solution that would be less complicated and which would require fewer resources than a super manager, such as that discussed here above.

More particularly, the invention aims to provide a system and a resource distribution device for distributing resources over time that is capable of distributing the resources amongst the managers over time, based on one or more constraints, and with this requiring only the addition of a device of moderate complexity with limited needs, rather than a heavy super management system for managing the managers themselves.

To this end, the present invention provides a system comprising: at least two resource and task managers, independent of each other; a cluster of shared resources common to the said managers; software that runs in the background interfaced with the said managers in a manner so as to appropriately distribute the resources of the said cluster between the said managers on the basis of one or more distribution parameters.

The resource and task managers are independent of each other, thus with neither one being encompassed by the other, nor therefore with a part of either one being simultaneously a part of the other. In addition, preferably, no hierarchical link exists between them, that is to say that neither one gives commands to the other who would then have to execute them; typically, neither one is a slave to the other who would then be its master. To this end, the present invention also provides software that runs in the background, which is interfaced or is capable of being interfaced with the resource and task managers that are independent of each other, in a manner so as to be able to appropriately distribute the resources of a shared cluster of resources common to the said managers, between the said managers, on the basis of one or more distribution parameters.

To this end, the present invention also provides a method for distribution of resources amongst managers by using software running in the background or a process running in the background, which is interfaced or is capable of being interfaced with the resource and task managers that are independent of each other, in a manner so as to be able to appropriately distribute the resources of a shared cluster of resources common to the said managers, between the said managers, on the basis of one or more distribution parameters.

To this end, the present invention also provides a resource distribution device for distributing resources between managers by using software running in the background or a device running in the background, which is interfaced or is capable of being interfaced with the resource and task managers that are independent of each other, in a manner so as to be able to appropriately distribute the resources of a shared cluster of resources common to the said managers, between the said managers, on the basis of one or more distribution parameters.

Whenever the term software is used, it could be replaced by the term “computer programme”. The software running in the background produces a technical effect of changing the allocation of software resources, such as computing nodes for example, to one or the other of the managers, in a manner so as to increase the overall degree to which these software resources are usefully occupied within the common cluster of software resources shared by the managers. Consequently, this software that produces an additional technical effect going beyond the simple interaction between the software and the computer on which it runs, further presents a technical character and is thus not a “software per se” (see the decision of the Enlarged Board of Appeal G3/08 of the European Patent Office).

The tool that is the object of the invention allows for a smoother transition without shutting down the production. This tool also enables administrators to install and configure the new manager without shutting down the production and by limiting the risks during the transition from the old manager to the new manager.

Moreover, it provides the ability to allow time for users to become familiar with the new manager and to adapt their tools accordingly.

The tool that is the object of the invention may present, depending upon the respective configurations, all or part of the following benefits:
capability to dynamically manage the fleet of machines, on account of the mathematical rule of distribution of machines, the profile of groups dedicated to each manager changing according to their respective loads;
a smooth transition for users: the users have the time to adapt their scripts so as to enable the launching / running of tasks automatically;
the maintenance of the independence of managers: the link between the two managers is effected by the tool. They coexist independently of each other without there being any need for any modification in the internal code to be carried out.
no shut down of the production environment: administrators can configure the profile of each group of machines and the rule for change according to their needs without having to shut down the entire cluster. Users are thus able to continue launching and running tasks without interruption, even during the transition phase at the time of moving from one manager to the other.

According to preferred embodiments, the invention comprises one or more of the following characteristic features that may be used separately, or in partial combination with each other, or in total combination with each other, as well as in combination with the objects previously mentioned above, the system, software, method and device.

Preferably, the said software running in the background is interfaced with the said managers in a manner so as to distribute the resources of the said cluster between the said managers in particular on the basis of their respective task loads. Thus, the rate of utilisation of resources remains optimised. Indeed, the distribution may be carried out in a manner such that a maximum level of resources is utilised most of the time.

Preferably, the said software running in the background is interfaced with the said managers in a manner so as to distribute the resources of the said cluster between the said managers in particular on the basis of their respective task loads usefully occupying the resources of the said cluster at a given instant in time, without taking into consideration the remaining time period of resource utilisation by the managers and without taking into consideration their future task loads. Thus, the software running in the background may be drastically less complex than would have been the case in the event of a super resource and task manager overlaid on top of the resource and task managers, since only the current task load at a given moment in time is considered and not the current and future task loads over a significant period of time (and not just at a given moment in time) which would require far greater levels of complexity and available power to be properly considered. No scheduling of tasks is performed at the level of the said software running in the background. This software running in the background does not require any software overlay on top of the software layer of the said managers. This software running in the background runs on the same management node as the managers that it coordinates.

Preferably, the said software running in the background is interfaced with the said managers in a manner so as to distribute the resources of the said cluster between the said managers in particular on the basis of a predefined rule for distributing resources between the said managers. Thus, an evolutionary change over the medium term, and not only over the short term, of the distribution of resources between managers may be brought about. This medium term distribution of resources, often a reconfiguration of the distribution of resources, may be implemented while simultaneously implementing a short term distribution of resources on the basis of the respective task loads of the managers. In this case, the predefined rule, in particular if it is a particularly rigid rule can be only partially complied with in reality because a compromise will be found with the distribution of resources on the basis of the respective task loads of the managers.

Preferably, the said predefined rule for distributing resources between the said managers provides for a predefined distribution of resources that varies over time.

While being predefined, this distribution of resources is not fixed; it may vary over the course of time, and may tend for example to make a lasting change in the average distribution of resources between the managers.

Preferably, the said predefined rule for distributing resources between the said managers provides for a predefined distribution of resources that brings about a progressive transfer of all the resources from one of the said managers to the other of the said managers, the said progressive transfer preferably being carried out in compliance with a predetermined limit on the rate of moving of resources from one of the said managers to the other of the said managers. Preferably, the said software running in the background is interfaced with the said managers in a manner so as to distribute the resources of the said cluster between the said managers over the transition time period during the switching from one manager to another manager for the said cluster of resources. For example, from a 0%/100% distribution at the start between the two managers, the system shifts to a 25%/75% distribution between these two managers over a first period, and then to a 50%/50% distribution between these two managers over a second period, and then to a 75%/25% distribution between these two managers over a third period, and finally to a 100%/0% distribution between these two managers over a fourth and last period: the replacement of one manager by another has then been carried out. Thus, the transition, for a cluster of given resources, from a first resource and task manager to a second resource and task manager may be brought about progressively and smoothly, while also maintaining a high level of availability of resources, even during the phase of transition between the first manager and the second manager. During the replacement of a first manager by a second manager, the management of all of the resources during the transition period provides the ability to maintain a high level of resource availability, and this is so with respect to the first as well as the second manager. Once again, even during the complete replacement of a first manager by a second manager, for a cluster of resources, the transition is carried out in a progressive and continuous manner, in a smooth and seamless flow without any sudden jolts or breaks.

Preferably the system comprises of only two managers that share the said cluster of resources. The software that runs in the background, in spite of its considerable simplicity and its low resource requirements, is perfectly sufficient for bringing about the harmonisation of resource management between the managers which are indeed only two in number.

Preferably, at least two of the said managers use operating software programmes that are different from each other, and preferably each of the said managers uses an operating software programme that is different from those of the other managers, and preferably, amongst the operating software programmes used, the programmes “ SLURM” (copyright) and/or “IBM Platform LSF” (copyright) and/or “Altair PBS Professional” (copyright) are included. The software that runs in the background, in spite of its considerable simplicity and its low resource requirements, allows for the flexible management of different operational software in use amongst the managers, which would otherwise have been the cause of significant difficulties, in particular due to the fact of there being no exact correspondence between the functionalities of the managers having different operational software and there also being no simple correspondence where such correspondence exists. The use of the software that runs in the background makes it possible to overcome this difficulty in a simple manner.

Preferably, the said software running in the background is interfaced with the said managers in a manner so as to distribute the resources of the said cluster between the said managers only at certain distribution moments, preferably when the said software running in the background is contacted by one of the said managers at least a part of the resources of which gets freed up due to the ending of at least one corresponding task and/or preferably regularly at moments that are advantageously predetermined in a periodic manner. On the one hand, each ending of a task and each freeing up of the corresponding resources occupied therein is the ideal moment in time to cause the switching of all or part of these resources from one manager to the other. On the other hand, in the event of the absence of any specific task ending, for example due to the lack of current tasks in process managed by a manager, the unused resources of this manager may thus quickly be reallocated to another manager who may have some tasks pending, on account of the lack of resources that have been allocated to it.

Preferably, the respective task loads of the said managers are dependent upon the number of computing nodes thereof occupied by the tasks. The resources considered that are to be distributed are then the computing nodes. In order to modify the distribution of computing nodes, for each manager, account is taken of the occupied computing nodes thereof and the free computing nodes thereof. The lower the proportion of occupied computing nodes thereof is, the greater will be the number of free computing nodes thereof that could be reallocated to another manager.

Preferably, when the resources of the said cluster are allocated either to a plurality of the said managers simultaneously or to none of the said managers at a moment in time when they should be so allocated, the said software that runs in the background, first allocates the said resources to one of the said managers and only to it, and then sends an alert to an administrator of the said system. A resource allocated simultaneously to two managers will tend to disrupt the system by making it slower and less efficient. A resource that is not allocated to any manager despite not being disabled, faulty or in maintenance mode, is a resource that is ungainfully underexploited, revealing a decrease in efficiency of the system. These two cases will most often correspond to instances of undesired malfunctioning. This is the reason why, the software running in the background firstly corrects them in order to restore an optimised efficiency to the system, and then sends an alert in order to ensure that the administrator of the system is able to intervene at their level if they so deem necessary.

Preferably, one of the distribution parameters for a given period is a moment in time within the period. This may for example be the time slot of the day or night, or indeed the weekend relative to the week. Thus in a manner derogating from a relatively balanced distribution of resources between managers, during certain specific time slots, such as during the middle of the night for example, all the resources are allocated to one single manager so as to enable the processing of one or more large tasks requiring the simultaneous use of all or almost all the resources of the cluster of resources.

Preferably, the distribution of resources between the said managers is carried out on the basis of their respective task loads and/or on the basis of a predefined resource distribution rule for distributing resources between the said managers.

Preferably, the invention also relates to a computer programme product, comprising of programme code instructions recorded on a medium readable by a computer, comprising of computer readable programming means for running in the background, computer readable programming means for being interfaced or for being capable of being interfaced with the resource and task managers, that are independent of each other, in a manner so as to be able to appropriately distribute the resources of a shared cluster of resources common to the said managers, between the said managers, on the basis of one or more distribution parameters, when the said programme is running on a computer.

Preferably this computer programme product comprises of programming means readable by computer in order for ensuring that the distribution of resources between the said managers is carried out on the basis of their respective task loads and/or on the basis of a predefined resource distribution rule for distributing resources between the said managers, when the said programme is running on a computer.

Other characteristic features and advantages of the invention become apparent upon reviewing the description that follows of a preferred embodiment of the invention, provided by way of example and with reference made to the accompanying drawings.

### BRIEF DESCRIPTION OF THE DRAWINGS

FIG. 1 schematically shows an example of the main elements of the architecture of a system that would use a super manager of managers.

FIG. 2 schematically shows an example of the main elements of the architecture of a system according to an embodiment of the invention.

FIG. 3 schematically shows an example detailing a part of the architecture of a system according to one embodiment of the invention.

FIG. 4 schematically shows an example detailing a part of the architecture of a system according to one embodiment of the invention, explaining the environment software running in the background.

FIG. 5 schematically shows an example of a process run by a system according to an embodiment of the invention.

### DETAILED DESCRIPTION OF THE INVENTION

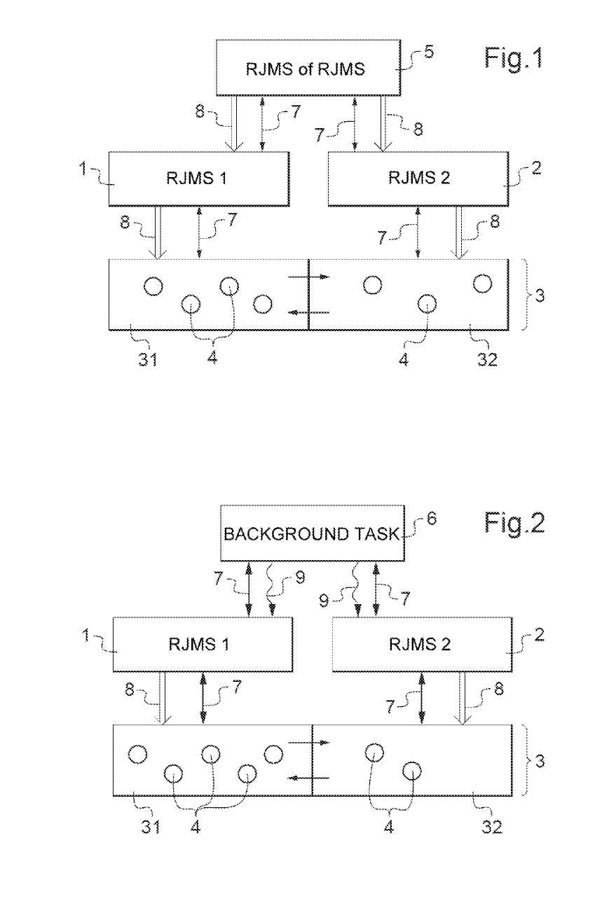

FIG. 1 schematically shows an example of the main elements of the architecture of a system that would use a super manager of managers and FIG. 2 schematically shows an example of the main elements of the architecture of a system according to an embodiment of the invention. The parts common to the two FIGS. 1 and 2 shall now be described. A task may even be called a job.

A first manager 1 and a second manager 2 share the computing nodes 4 of a common cluster 3 of computing nodes 4. At any given time instant, except in particular cases, the nodes 4 are either allocated to the first manager 1, in which case they are in the group 31 of nodes, or allocated to the second manager 2, in which case they are in the group 32 of nodes. Over the course of time, this allocation may change. The nodes 4 may pass, when they are free, from one group to the other and vice versa.

Each manager exchanges information with the nodes in its group, which is represented by the bidirectional information exchange arrow 7. Each manager manages the nodes 4 in its group by scheduling tasks with respect to these nodes 4, which is represented by the one directional scheduling arrow 8.

In addition to providing the options and settings and parameters that are specific to them, the managers 1 and 2 provide the ability to run standard scripts defined by the administrators of the machine before and after each task. This script has knowledge of certain parameters of tasks in the form of environment variables. Among these parameters is the list of nodes 4 used for the task completed. It is thus possible to add, in the script that follows the tasks, a command to be used for calling the tool, and to have, as a parameter for this command, the list of nodes 4. This command gives the list of the nodes 4 from which it may thus be decided to change one, more than one, all or none of these nodes 4 of the manager depending upon the number of nodes 4 in each of the managers 1 and 2 and their respective loads. In order to switch a node 4 from one manager to another, each manager's commands are called upon enabling changing the status of nodes 4. On the “initial” manager, for example the first manager 1, this node 4 is set to “unavailable”, while on the “destination ” manager, for example the second manager 2, this node 4 is set to “available”. This list of nodes 4 is provided during the exchange 7 of information between on the one hand, the managers 1 and 2 and on the other hand, either the super manager 5 for FIG. 1, or the device running in the background 6 for FIG. 2.

For a given manager, the nodes 4 are “unavailable” or when they are available, they may be “free” (idle) or “occupied” (in the process of executing a task or a calculation).

FIG. 1 schematically shows an example of the main elements of the architecture of a system that would use a super manager of managers. The parts specific to the FIG. 1 shall now be described. A super manager 5 manages the managers 1 and 2 by exchanging information with them and by scheduling tasks for them. This system would be complex and would require a significantly high level of resources. In addition, the overlaying of the scheduling performed by the managers with the scheduling performed by the super manager may prove to be difficult to implement or manage, in particular with regard to the risks of decision making conflict between the managers and the super manager.

FIG. 2 schematically shows an example of the main elements of the architecture of a system according to an embodiment of the invention. The parts specific to the FIG. 2 shall now be described. A device or software running in the background 6 exchanges information with the managers 1 and 2 and instructs them as to the nodes 4 to be exchanged between them, but it does not manage them, it does not schedule the tasks based on the managers 1 and 2. This system is simple and requires only a limited level of resources. This simple reallocation of nodes 4 between the managers 1 and 2 is represented by the unidirectional arrow of reallocation 9.

It is interesting that the device running in the background 6 periodically checks the status of the nodes 4 so as to be sure that the two managers 1 and 2 are not using the same nodes simultaneously and to ensure that no node is set to “unavailable” on both the managers 1 and 2 simultaneously, of course with the exception of particular cases, such as manipulation by the administrator in order to perform maintenance, or as in the case of a failure.

The parameters for distribution between the managers may be of several types, in accordance with a predefined distribution rule and/or on the basis of their respective task loads.

When the distribution parameter is a predefined distribution rule, it may be of several types. For example, in the case where a new manager is set in place, it begins with 0 node and is expected to use, after a defined period of time has elapsed, a certain percentage of nodes of the cluster of common nodes. Or indeed for example, in the event where each manager is expected to use 50% of the nodes on a continuous ongoing basis, and this notwithstanding the nodes that are shut down (for example due to failure) or are set to undergo maintenance by the administrator. Or indeed for example, as in the event where a minimum number of nodes for each manager must be retained, in spite of failures and maintenance operations.

When the distribution parameter depends on the respective task loads of the managers, it may be of several types. For example, having a distribution proportional to the number of nodes required. Or indeed, for example, forcing a rate of utilisation of around 50% for each manager from 08:00 hrs to 18:00 hrs, a time slot from 20:00 hrs to 00:00 hr and another from 02:00 hrs to 06:00 hrs with a 0%/100% distribution and the intermediate time slots allowing for a smooth transition of tasks.

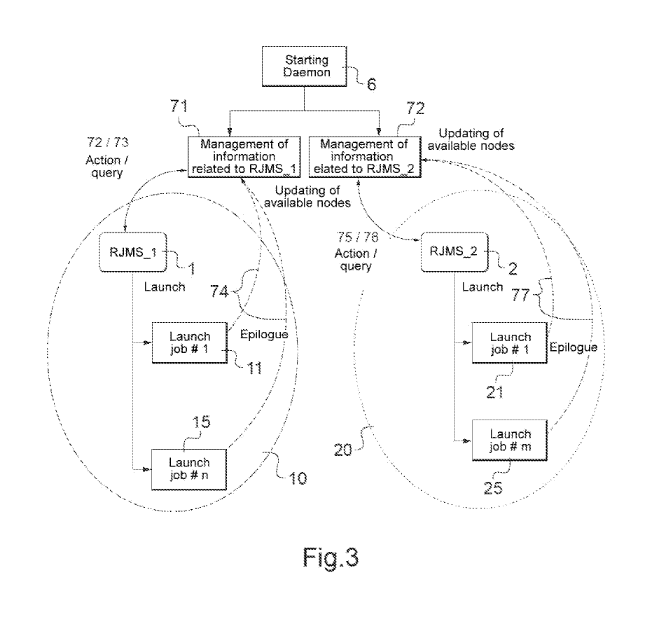

FIG. 3 schematically shows an example detailing a part of the architecture of a system according to an embodiment of the invention. The device running in the background 6 is responsible for distributing the computing nodes available between the managers 1 and 2. The manager 1 has a set 10 of tasks 11 to 15 to run. At the end of each task 11 to 15, a message 74 corresponding to a task ending is sent to the information management module 71 of the manager 1. The manager 1 also sends information in response to the query 73 originating from the device running in the background 6 by means of the information management module 71 of the manager 1. Still by means of the information management module 71 of the manager 1, the device running in the background 6 indicates, by an action 72 to the manager 1 the nodes which have been allocated to it and the nodes which have been taken away from it.

The manager 2 has a set 20 of tasks 21 to 25 to be run. At the end of each task 21 to 25, a message 77 corresponding to a task ending is sent to the information management module 72 of the manager 2. The manager 2 also sends information in response to the query 76 originating from the device running in the background 6 by means of the information management module 72 of the manager 2. Still by means of the information management module 72 of the manager 2, the device running in the background 6 indicates, by an action 75 to the manager 2 the nodes which have been allocated to it and the nodes which have been taken away from it.

The tool includes a device or software running in the background 6 (daemon in English) that runs on the same management node as the managers 1 and 2. This device running in the background 6 will know which managers are being used and will know certain commands for each of them. These commands are for example querying the managers so as to determine the status of the nodes, or indeed for example querying the managers so as to determine the characteristics of tasks initiated and still pending, the number of nodes required for each task and the time required to perform each task, or indeed for example changing the status of a node from a “free” status to an “unavailable” status and vice versa.

The device running in the background 6 will have two sets of external commands. The first set of external commands will allow the administrator to manage the number of nodes allocated to each manager. The second set of external commands include the commands called at the end of each task of each manager in order to define whether or not the nodes of this task should be moved to the other manager.

The device running in the background 6 will have configuration commands that will enable it to define the objectives and constraints on the allocation of nodes to the managers 1 and 2. These objectives and constraints may for example be a minimum number of nodes for each of the managers as well as a maximum number, or indeed for example the fact that certain nodes may not be moved from one manager to the other, or even imposing a maximum rate of movement, for example, a limit on the number of nodes moved per minute, from one manager to the other.

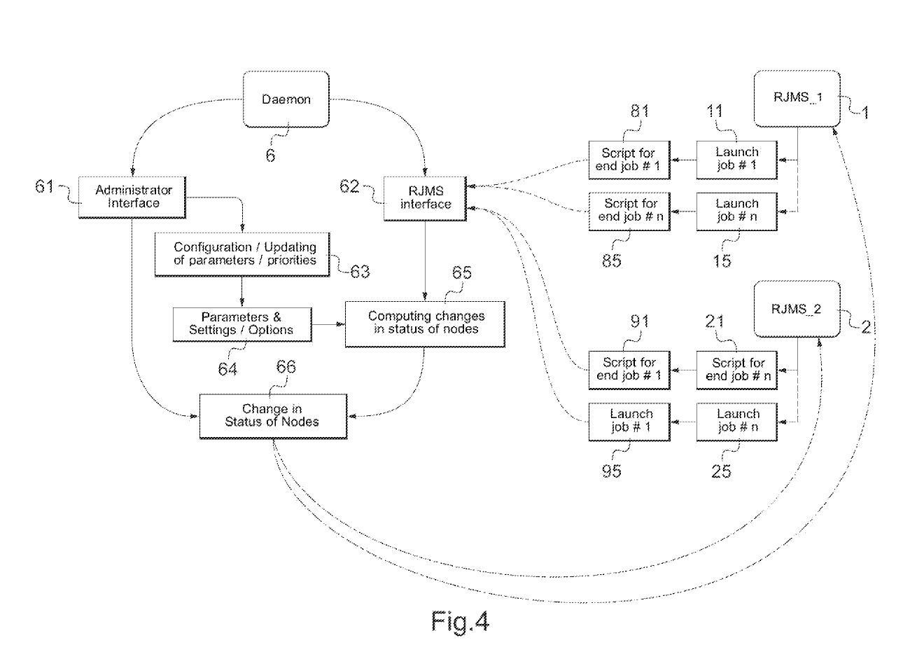

FIG. 4 schematically shows an example detailing a part of the architecture of a system according to one embodiment of the invention, explaining the environment of the software running in the background. The manager 1 has a set of tasks 11 to 15 to be performed. At the end of each task 11 to 15, a task end script 81 to 85 is sent to a manager interface 62 of the device running in the background 6. Similarly, the manager 2 has a set of tasks 21 to 25 to be performed. At the end of each task 21 to 25, a task end script 91 to 95 is sent to the manager interface 62 of the device running in the background 6.

The device running in the background 6 is connected both to its manager interface 62 as well as to an administrator interface 61. The administrator interface 61 sets up in 63 a configuration or an update both the parameters as well as the priorities, which provides a group 64 of parameters and options which are used in conjunction with the information originating from the manager interface 62, in order to set up in 65 the computing the nodes that have to change status, which results in the list 66 of status changes of nodes, supervised by the administrator through the administrator interface 61, a list 66 that is communicated both to the manager 1 as well to the manager 2.

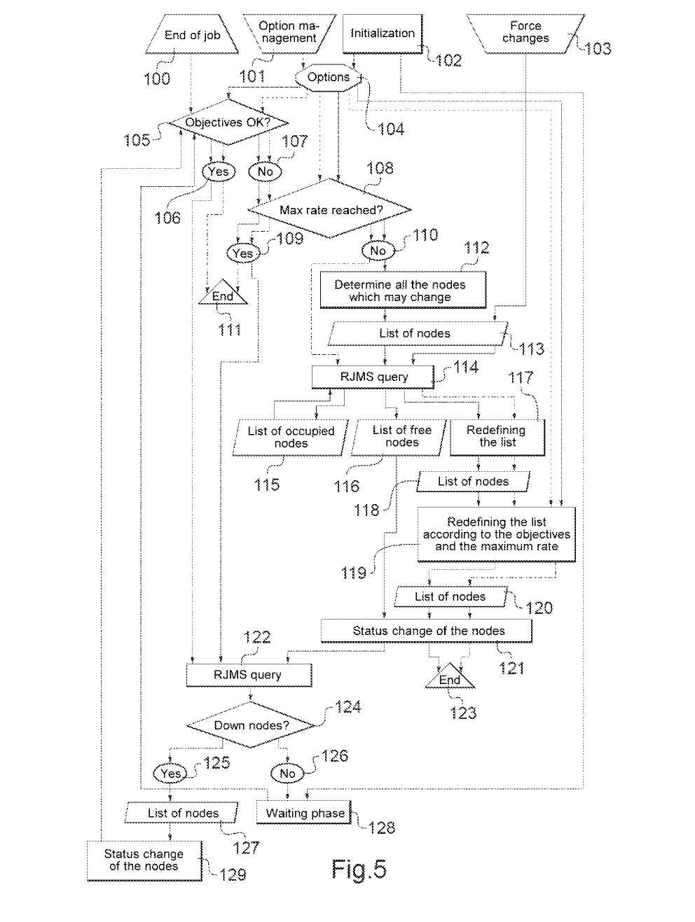

FIG. 5 schematically shows an example of a process sequence run by a system according to one embodiment of the invention. The trapezoids normally represent a system call, the inverted trapezoids normally represent an intervention by the administrator, the rectangles normally represent an action, the diamond shapes normally represent an alternative, the ellipses normally represent the branches of an alternative, the parallelograms normally represent inputs/outputs, the triangles represent the process sequence ends.

Upon initialisation 102, the software running in the background is launched; it will run continuously and will only be stopped through an intervention by the administrator. Then comes a waiting phase 128. Subsequently, a scan 105 to check the achievement of objectives is performed.

In case of a positive scan 106, a manager query 122 is performed. A verification check 124 of failed nodes is performed. In the absence 126 of failed nodes, one returns to the waiting phase 128 and the loop continues. In the presence 125 of failed nodes, a listing 127 of these failed nodes is generated, a change 129 of status of failed nodes is effected, and one returns to a scan 105 to check the achievement of objectives and the loop continues.

In case of a negative scan 107, the verification check 108 is performed to determine whether or not the maximum rate of transfer of nodes from one manager to the other has been reached. In case of this maximum rate of transfer being reached 109 one returns to the manager query 122 and the loop continues. In case of not reaching 110 this maximum rate of transfer, a determination 112 of all the nodes that are able to change managers is performed, which leads to the establishment 113 of the list of nodes that are able to change, which results in a new manager query 114, leading in its turn to a list redefinition 117, resulting anew in the establishment 118 of the list of nodes that are able to change, leading to a new redefinition 119 of this list, but this time based on the objectives and the maximum rate of transfer, resulting in an additional establishment 120 of the list of nodes that are able to change, followed by a change 121 of status of the nodes, and one returns to the manager query 122 and the loop continues.

At the end of each task 100, a scan 105 to check the achievement of objectives is performed. In case of a positive control 106, it is the end 111 of the process sequence. In case of a negative scan 107, the verification check 108 is performed to determine whether or not the maximum rate of transfer of nodes from one manager to the other has been reached.

In case of this maximum rate of transfer being reached 109 it is the end 111 of the process sequence. In case of not reaching 110 this maximum rate of transfer, it results in a new manager query 114, leading in its turn to a list redefinition 117, resulting anew in the establishment 118 of the list of nodes that are able to change, leading to a new redefinition 119 of this list, but this time based on the objectives and the maximum rate of transfer, resulting in an additional establishment 120 of the list of nodes that are able to change, followed by a change 121 of status of the nodes, and this is the end 123 of the sequence of the process.

During a forced change 103, through intervention by the administrator it leads to the establishment 113 of the list of nodes that are able to change, which results in a new manager query 114, bringing about the establishment 115 of a list of occupied nodes, followed by a new manager query 114, and then the establishment 116 of a list of free nodes, followed by a change 121 of status of the nodes, and this is the end 123 of the process sequence.

During the initialisation 102, a modification 104 of options may also be implemented, which will be used by the new list redefinition 119, by the verification 108 of whether or not the maximum rate of transfer has been reached, by the scan 105 to check the achievement of objectives.

A management of options 101 may also be performed through intervention by the administrator, followed by a modification 104 of options, which will be used by the new list redefinition 119, by the verification 108 of whether or not the maximum rate of transfer has been reached, by the scan 105 to check the achievement of objectives.

Quite obviously, the present invention is not limited to the examples and embodiments described and shown, rather it is capable of being implemented in a number of variants accessible to the person skilled in the art.

What is claimed is:

1. A system comprising:
at least two resource and task managers, independent of each other;
a cluster of shared resources common to the said managers;
software that runs in the background interfaced with the said managers in a manner so as to appropriately distribute the resources of the said cluster between the said managers on the basis of one or more distribution parameters.

2. The system according to claim 1, characterised in that the said software running in the background is interfaced with the said managers in a manner so as to appropriately distribute the resources of the said cluster between the said managers in particular on the basis of their respective task loads.

3. The system according to claim 2, characterised in that the said software running in the background is interfaced with the said managers in a manner so as to appropriately distribute the resources of the said cluster between the said managers in particular on the basis of their respective task loads usefully occupying the resources of the said cluster at a given instant in time, without taking into consideration the remaining time period of resource utilisation by the managers and without taking into consideration their future task loads.

4. The system according to claim 1, characterised in that the said software running in the background is interfaced with the said managers in a manner so as to appropriately distribute the resources of the said cluster between the said managers in particular on the basis of a predefined rule for distributing resources between the said managers.

5. The system according to claim 4, characterised in that the said predefined rule for distributing resources between the said managers provides for a predefined distribution of resources that varies over time.

6. The system according to claim 5, characterised in that the said predefined rule for distributing resources between the said managers provides for a predefined distribution of resources that brings about a progressive transfer of all the resources from one of the said managers to the other of the said managers, the said progressive transfer preferably being carried out in compliance with a predetermined limit on the rate of moving of resources from one of the said managers to the other of the said managers.

7. The system according to claim 6, characterised in that the said software running in the background is interfaced with the said managers in a manner so as to appropriately distribute the resources of the said cluster between the said managers over the transition time period during the switching from one manager to another manager for the said cluster of resources.

8. The system according to claim 1, characterised in that the system comprises of only two managers that share the said cluster of resources.

9. The system according to claim 1, characterised in that at least two of the said managers use operating software programmes that are different from each other, and in that preferably each of the said managers uses an operating software programme that is different from those of the other managers.

10. The system according to claim 1, characterised in that the said software running in the background is interfaced with the said managers in a manner so as to appropriately distribute the resources of the said cluster between the said managers only at certain distribution moments, preferably when the said software running in the background is contacted by one of the said managers at least a part of the resources of which gets freed up due to the ending of at least one corresponding task and/or preferably regularly at moments that are advantageously predetermined in a periodic manner.

11. The system according to claim 1, characterised in that the respective task loads of the said managers are dependent upon the number of computing nodes thereof occupied by the tasks.

12. The system according to according to claim 1, characterised in that, when the resources of the said cluster are allocated either to a plurality of the said managers simultaneously or to none of the said managers at a moment in time when they should be so allocated, the said software that runs in the background, first allocates the said resources to one of the said managers and only to it, and then sends an alert to an administrator of the said system.

13. The system according to claim 1, characterised in that one of the distribution parameters for a given period is a moment in time within the period.

14. A computer programme product comprising of programme code instructions recorded on a medium readable by a computer, comprising of:
computer readable programming means for running in the background,
computer readable programming means for being interfaced or for being capable of being interfaced with the resource and task managers, that are independent of each other, in a manner so as to be able to appropriately distribute the resources of a shared cluster of resources common to the said managers, between the said managers, on the basis of one or more distribution parameters, when the said programme is running on a computer.

15. The computer programme product according to claim 14, characterised in that it comprises of programming means readable by computer in order for ensuring that the distribution of resources between the said managers is carried out on the basis of their respective task loads and/or on the basis of a predefined resource distribution rule for distributing resources between the said managers, when the said programme is running on a computer.
